(19) United States
(12) Patent Application Publication
(10) Pub. No.: US 2003/0000918 A1
(43) Pub. Date: Jan. 2, 2003

(54) Method for fabricating a protective cap for an optical waveguide core of a planar lightwave circuit device

(76) Inventors: Nizar S. Kheraj, San Jose, CA (US); Pamela S. Trammel, San Jose, CA (US); Fan Zhong, Fremont, CA (US); Jonathan G. Bornstein, Cupertino, CA (US)

Correspondence Address: WAGNER, MURABITO & HAO LLP, Third Floor, Two North Market Street, San Jose, CA, 95113, US

(21) Appl. No.: 09/895,341

(22) Filed: Jun. 29, 2001

(51) Int. Cl. G02B 6/00

(52) U.S. Cl. 216/24

(57) ABSTRACT

In a planar lightwave circuit, a method of making an optical waveguide that resists core deformation. The method includes a step of forming a core layer on a bottom clad. A waveguide core is formed from the core layer using an etching process. The waveguide core is fabricated to have a higher refractive index than the bottom clad. A silica glass cap layer is then formed over the waveguide core and the bottom clad. A top clad is then formed over the waveguide core, the silica glass cap layer, and the bottom clad. The waveguide core has a higher refractive index than the top clad. The silica glass cap layer maintains the shape of the waveguide core during an anneal process of the top clad. The silica glass cap layer can be deposited using PECVD (plasma enhanced chemical vapor deposition). The silica glass cap layer can be between 0.3 to 2 microns thick. The silica glass cap layer can be undoped silica glass. The silica glass cap layer can have a higher reflow temperature than the waveguide core to prevent deformation of the waveguide core. The silica glass cap layer also can prevent diffusion of dopant between the waveguide core and the top clad.

### TECHNICAL FIELD

The present invention relates generally to the fabrication of planar lightwave circuits. More particularly, the present invention relates to a method and system for fabricating a silica glass cap for an optical waveguide core of a planar lightwave circuit.

### BACKGROUND ART

Planar lightwave circuits comprise fundamental building blocks for the modern fiber optic communications infrastructure. Planar lightwave circuits are generally devices configured to transmit light in a manner analogous to the transmission of electrical currents in printed circuit boards and integrated circuit devices. Examples include arrayed waveguide grating devices, integrated wavelength multiplexers/demultiplexers, optical switches, optical modulators, attenuators, wavelength-independent optical couplers, and the like.

Planar lightwave circuits (PLCs) generally involve the provisioning of a series of embedded optical waveguides upon a semiconductor substrate (e.g., silicon). PLCs are constructed using the advanced tools and technologies developed by the semiconductor industry. Modern semiconductor electronics fabrication technology can aggressively address the increasing need for integration and is currently being used to make planar light circuits. By using manufacturing techniques closely related to those employed for silicon integrated circuits, a variety of optical elements can be placed and interconnected on the surface of a silicon wafer or similar substrate. This technology has only recently emerged and is advancing rapidly with leverage from the more mature tools of the semiconductor-processing industry.

A conventional PLC optical waveguide comprises a substrate (e.g., silicon) with a un-doped silica glass bottom clad formed thereon, at least one waveguide core formed on the bottom clad, and a top clad covering the waveguide core and the bottom clad, wherein a certain amount of at least one dopant is added to the waveguide core so that the refractive index of the waveguide core is higher than that of the top clad and bottom clad. The waveguide cores are formed by etching their profile from a core layer (e.g., doped SiO₂ glass) deposited over the bottom clad. The core layer is then heated to more than 1000 C. to stabilize its refractive index. The core layer is patterned by, for example, reactive-ion etching to remove the excess doped SiO₂ glass, and thereby define the profile of one or more waveguide cores. An SiO₂ cladding layer is then formed (e.g., by flame deposition). The optical waveguide is subsequently heated to a temperature of more than 1000° C. to stabilize the refractive index of the top clad and to make the top clad more homogenous. Finally, the wafer is diced cut into multiple PLC dies and packaged according to their particular applications.

Prior art FIG. 1 shows a cross-section view of a conventional planar optical waveguide. As depicted in FIG. 1, the planar optical waveguide includes a doped SiO₂ glass core 10 formed over a SiO₂ silica glass bottom clad 12. A SiO₂ top clad 11 covers both the waveguide core 10 and the bottom clad 12. As described above, the refractive index of the core 10 is higher than that of the top clad 11 and the bottom clad 12. Consequently, optical signals are confined axially within core 10 and propagate lengthwise through core 10.

Top clad 11 is formed using a very gradual top clad “buildup” process, wherein a number of deposition and anneal cycles are used to gradually buildup the thickness of the top clad layer. Successive thin top clad layers (e.g., typically 4 layers at minimum) are deposited and annealed in order to make the top clad more homogenous and avoid the formation of defects (e.g., voids, crystallization areas, etc.) and to stabilize the refractive index of top clad 11. The use of multiple deposition and anneal cycles is also effective in filling high aspect ratio gaps, wherein a number of waveguide cores are located closely together and the top clad deposition process needs to effectively fill these gaps between the waveguide cores.

There exists a problem however, in maintaining a precise waveguide core profile through successive anneal cycles. During the top clad buildup process, each time a thin layer of the top clad is deposited (e.g., using PECVD), it subsequently treated with a high temperature anneal cycle (e.g., 1000-1200 C.). The high temperature anneal cycle is used to fix the refractive index of the newly deposited layer and to reflow the layer into gaps. Unfortunately, the high temperature anneal cycle also tends to cause some degradation in the shape of the waveguide core. For example, instead of maintaining its precise rectangular shape, after three or more anneal cycles, waveguide core 10 can be deformed, losing its precisely defined rectangular shape.

Prior art FIG. 2 shows a cross-section diagram of a waveguide core 20 having undergone significant deformation due to multiple high-temperature anneal cycles. As depicted in FIG. 2, the vertical sides of waveguide core 20 are deformed, as waveguide core 20 “reflows” and settles due to gravity under the high temperatures (e.g., 1000 C. or above).

Prior art FIGS. 3A and 3B show cross-section photographs of waveguide cores showing similar types of deformation due to the high temperature anneal cycles. As with waveguide core 20, temperatures near or above the waveguide core's reflow temperature causes deformation, particularly in the waveguide core sidewalls.

Waveguide core deformation is a significant problem for several types of high-performance PLCs. For example, arrayed waveguide grating (AWG) PLCs are one of the most precisely manufactured PLCs, and are used to implement multiplexing or demultiplexing functions within a fiber-optic network. A typical AWG device is configured for multiplexing or demultiplexing, for example, 16 channels with a separation of 100 gigahertz between the channels. AWG devices having 40 channels spaced at 50 gigahertz are commercially available, and even more advanced devices having 128 channels spaced at 25 gigahertz have been demonstrated. The performance of such advanced AWG devices (e.g., 40 channels or more) is critically dependent upon the performance of the semiconductor manufacturing technologies used to fabricate them. For example, a 128 channel AWG device will have at least 128 precisely defined optical waveguides fabricated therein. Waveguide core deformations or other such imperfections are likely to have very significant impacts upon the performance of the AWG device.

Additionally, other types of PLCs (e.g., couplers, optical switches, etc.) depend upon precisely defined waveguide cores located very close together, to form a coupling region. The transfer of light across this coupling region is dependent upon the precise dimensions of the waveguides in the coupling region. Waveguide core deformation in the coupling region can render the resulting device inoperative.

Thus what is needed is a solution that can effectively protect the profile of waveguide cores during top clad anneal. What is needed is a solution that can protect the profile of waveguide cores during multiple anneal cycles, as used in a top clad buildup process. Additionally, the required solution should not interfere with the performance of the completed optical waveguides. The present invention provides a novel solution to the above requirements.

### SUMMARY OF THE INVENTION

The present invention is a method and system for fabricating a cap layer over a waveguide core in order to protect the profile of the waveguide core during top clad anneal. The present invention maintains and protects the profile of waveguide cores during multiple anneal cycles, as used in a top clad buildup process. Additionally, the present invention does not interfere with the performance of the completed optical waveguides.

In one embodiment, the present invention is implemented as a PLC fabrication method for making optical waveguides that resist core deformation. The method includes a step of forming a core layer on a bottom clad. A waveguide core is formed from the core layer using an etching process. A silica glass cap layer is then formed over the waveguide core and the bottom clad. A top clad is then formed over the waveguide core, the silica glass cap layer, and the bottom clad.

The silica glass cap layer maintains the shape of the waveguide core during a anneal process for a multistep top clad build up process. The silica glass cap layer can be deposited using PECVD (plasma enhanced chemical vapor deposition). The silica glass cap layer can be between 0.3 to 2 microns thick. In one embodiment, the cap layer can be undoped silica glass. The silica glass cap layer has a higher reflow temperature than the waveguide core to prevent deformation of the waveguide core. The silica glass cap layer also can prevent diffusion of dopant between the waveguide core and the top clad.

### BRIEF DESCRIPTION OF THE DRAWINGS

The present invention is illustrated by way of example and not by way of limitation, in the Figures of the accompanying drawings and in which like reference numerals refer to similar elements and in which:

Prior art FIG. 1 shows a cross-section view of a conventional planar optical waveguide.

Prior art FIG. 2 shows a cross section diagram of a waveguide core having undergone significant deformation due to multiple high-temperature anneal cycles.

Prior art FIG. 3A shows a first cross-section photograph of waveguide cores showing deformation due to high temperature anneal cycles.

Prior art FIG. 3B shows a second cross-section photographs of a waveguide core showing deformation due to high temperature anneal cycles.

FIG. 4 shows a cross-section view of an optical waveguide structure in accordance with one embodiment of the present invention.

FIG. 5A shows a waveguide core after deposition of a cap layer in accordance with one embodiment of the present invention.

FIG. 5B shows a cap structure in accordance with one embodiment of the present invention formed from the cap layer.

FIG. 6A shows a first layer of a top clad build up process, with a silica glass cap structure protecting the shape of a waveguide core.

FIG. 6B shows a second layer of the top clad build up process.

FIG. 6C shows a third layer of the top clad build up process.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to obscure aspects of the present invention unnecessarily.

Embodiments of the present invention are directed towards a method of fabricating a cap layer over a waveguide core in order to protect the profile of waveguide core during top clad anneal. The present invention protects the profile of waveguide cores during multiple anneal cycles, as used in a top clad buildup process. Additionally, the present invention does not interfere with the performance of the completed optical waveguides. The present invention and its benefits are further described below.

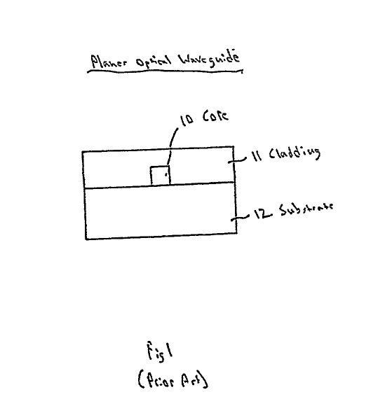

FIG. 4 shows a cross-section view of an optical waveguide structure 400 in accordance with one embodiment of the present invention. As depicted in FIG. 4, optical waveguide structure 400 is shown in a state subsequent to etching to remove a core layer used to form waveguide core 410, hereafter referred to as core 410. The core 410 is formed over a bottom clad layer 412. Core 410 is a doped silica glass core (e.g., Germanium dopant, Phosphorus dopant, or the like) in accordance with the present invention.

It should be appreciated that the major steps of silicon oxide deposition, photolithography, and fabrication are well known and widely used in planar lightwave circuit fabrication. Accordingly, such steps will not be described in extensive detail.

Referring still FIG. 4, during fabrication, a core layer is formed on bottom clad 412, wherein the core layer has a higher refractive index than bottom clad 412. Bottom clad layer 412 can be a silicon dioxide layer formed over a silicon substrate (not shown). Core 410 is then formed from the core layer using an etching process. As is well known in the art, once the core layer is deposited and annealed, a mask (not shown) is formed over the core layer using photolithography techniques. The unmasked areas of the core layer are then etched away to define the shape of core 410. The mask is subsequently removed from core 310, such that the optical waveguide structure 400 appears as shown in FIG. 4.

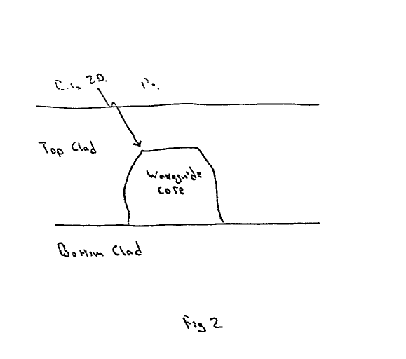

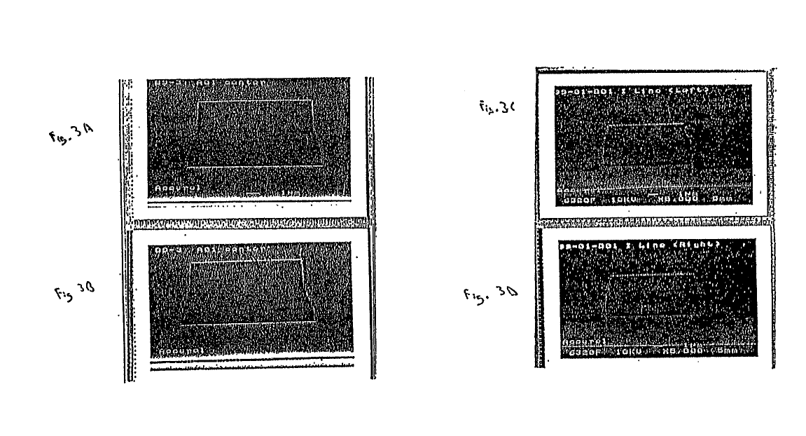

FIG. 5A shows core 410 after deposition of a cap layer 415. A silica glass cap layer 415 is formed over the core 410 and bottom clad 412. The silica glass cap layer can be deposited using PECVD (plasma enhanced chemical vapor deposition) and other similar process. The silica glass cap layer can be between 0.3 to 2 microns thick. In this embodiment, the silica glass cap layer is undoped silica glass (USG).

FIG. 5B shows a cap 420 formed from the cap layer 415. Once the layer 415 is deposited, a mask (not shown) is formed over the cap layer (e.g., using photolithography techniques). The unmasked areas of the cap layer 415 are then etched away to remove that portion of cap layer 415 covering the bottom clad 412, thus defining the shape of cap 420. The mask is subsequently removed from cap 420, such that the optical waveguide structure appears as shown in FIG. 5B.

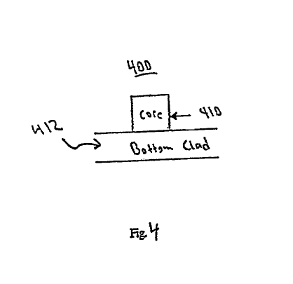

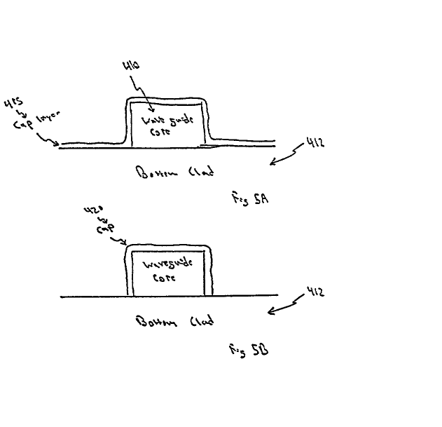

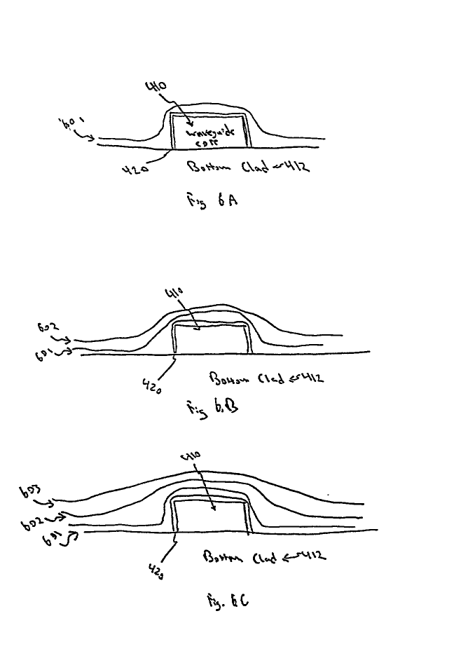

FIGS. 6A through 6C depict a top clad deposition process wherein a number of deposition and anneal steps are used to buildup a top clad over core 410 and cap 420. A well known problem with the fabrication of planar optical waveguide devices is the gap fill of high aspect ratio areas. To solve this problem, a very gradual top clad “buildup” process is used, wherein a number of deposition and anneal cycles are used to gradually buildup the thickness of the top clad layer. Successive thin top clad layers (e.g., typically 4 layers at minimum) are deposited and annealed in an attempt to avoid the formation of voids. Three such layers 601-603 are shown. FIG. 6A shows a top clad layer 601 over core 410 and cap 420. After deposition and anneal of layer 601, a second layer 602 is deposited and annealed, shown in FIG. 6B. FIG. 6C shows a third layer 603 deposited over the first layer 601 and second layer 602.

In this manner, the gradual top clad buildup process proceeds until the top clad is at the desired thickness. As known by those skilled in the art, the high temperature anneal cycles fix the refractive index of the deposited layers 601-603 and promotes more effective gap filling. In accordance with the present invention, the protective cap 420 prevents degradation in the shape of core 410 during each of the successive anneal cycles for the top clad.

The USG cap 420 generally has a higher reflow temperature than core 410 to prevent deformation of the profile core 410. The USG cap 420 also can prevent diffusion of dopant between core 410 and the top clad (e.g., top clad layers 601-603). The higher reflow temperature of the USG cap 420 protects the profile of waveguide cores during multiple anneal cycles, as used in the top clad buildup process, since cap 420 will tend to “contain” core 410 as core 410 reaches its lower reflow temperature.

Thus, cap 420 maintains the precise profile of core 410 through successive high temperature anneal cycles (e.g., 1000-1200 C.). The annealing procedure can proceed at higher temperatures and for a longer duration, wherein the top clad layers and the core 410 are repeatedly heated to temperatures above 1000 C. and the cap structure protects the shape of the waveguide core. The high temperatures are used to expel the undesired chemical substance, such as the radicals with bonded hydrogen, and to reduce the inhomogenities of refractive index within the top clad.

It should be noted that the thickness of the cap layer 415 (shown in FIG. 5A) should be configured to provide containment for core 410 while at the same time minimizing its effect on the optical properties of core 410. For example, as the thickness of cap layer 415 increases, the amount of birefringence caused by cap layer 415 increases. Simultaneously, the degree of protection for the shape of core 410 also increases. In the present embodiment, the optimum thickness of cap layer 415 is in a range from 0.5 microns to 1.5 microns. Thicknesses below 0.5 microns cannot provide an adequate amount of protection for core 410. The thicknesses above 1.5 microns introduce too much birefringence.

Thus, the present invention provides a method of fabricating a cap layer over a waveguide core in order to protect the profile of waveguide core during top clad anneal. The present invention protects the profile of waveguide cores during multiple anneal cycles, as used in a top clad buildup process. Additionally, the present invention does not interfere with the performance of the completed optical waveguides.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

What is claimed is:

1. In a planar lightwave circuit, a method of making an optical waveguide that resists core deformation, comprising the steps of:
a) forming a core layer on a bottom clad;
b) forming a waveguide core from the core layer using an etching process, the waveguide core having a higher refractive index than the bottom clad;
c) forming a silica glass cap layer over the waveguide core and the bottom clad;
d) forming a top clad over the waveguide core, the silica glass cap layer, and the bottom clad, the waveguide core having a higher refractive index than the top clad, wherein the silica glass cap layer maintains the shape of the waveguide core during an anneal process of the top clad.

2. The method of claim 1 further including the step of using an etching process to remove that portion of the silica glass cap layer deposited on the bottom clad during step c) by using an etching process.

3. The method of claim 1 wherein the silica glass cap layer is between 0.3 to 2 microns thick.

4. The method of claim 1 wherein the silica glass cap layer is undoped silica glass.

5. The method of claim 1 wherein the silica glass cap layer is configured to prevent diffusion of dopant between the waveguide core and the top clad.

6. The method of claim 1 wherein the silica glass cap layer is deposited using PECVD (plasma enhanced chemical vapor deposition).

7. The method of claim 1 wherein the silica glass cap layer has a higher reflow temperature than the waveguide core.

8. A method of making a capped optical waveguide core for a planar lightwave circuit, the method comprising the steps of:
a) forming a bottom clad on a silicon substrate;
b) forming a core layer on the bottom clad, the core layer having a higher refractive index than the bottom clad;
c) forming a core from the core layer; and
d) forming a silica glass cap layer over the core and the bottom clad;
e) forming a top clad over the core wherein the cap layer prevents core deformation during an anneal process of the top clad, wherein the anneal process is at a temperature of at least 1000 C.

9. The method of claim 8 further including the step of using an etching process to remove that portion of the silica glass cap layer deposited on the bottom clad during step c) by using an etching process.

10. The method of claim 8 wherein the silica glass cap layer is between 0.3 to 2 microns thick.

11. The method of claim 8 wherein the silica glass cap layer is undoped silica glass.

12. The method of claim 8 wherein the silica glass cap layer is configured to prevent diffusion of dopant between the waveguide core and the top clad.

13. The method of claim 8 wherein the silica glass cap layer is deposited using PECVD (plasma enhanced chemical vapor deposition).

14. The method of claim 8 wherein the silica glass cap layer has a higher reflow temperature than the waveguide core.

15. A method of making a silica glass cap for protecting the shape of the waveguide core during an anneal process for the top clad, comprising the steps of:
a) forming a silica glass cap layer over the waveguide core, wherein the silica glass cap layer is between 0.3 to 2 microns thick; and
b) forming a top clad over the waveguide core, the silica glass cap layer using a multistep deposition and anneal process, wherein the silica glass cap layer maintains the shape of the waveguide core during the anneal process.

16. The method of claim 15 wherein the silica glass cap layer is undoped silica glass.

17. The method of claim 15 wherein the silica glass cap layer is deposited using PECVD (plasma enhanced chemical vapor deposition).

18. The method of claim 15 wherein each of the steps of the anneal process from step c) are at a temperature of at least 1000 C.
